(19) United States
(12) Patent Application Publication
(10) Pub. No.: US 2013/0084454 A1
(43) Pub. Date: Apr. 4, 2013

(54) RESIN COMPOSITION, RESIN AND METHOD FOR MANUFACTURING THE SAME

(71) Applicants: Hsien-Kuang Lin, Hsinchu City (TW); Man-Lin Chen, Houlong Township (TW); Sue-May Chen, Taipei City (TW); Jauder Jeng, Taichung City (TW)

(72) Inventors: Hsien-Kuang Lin, Hsinchu City (TW); Man-Lin Chen, Houlong Township (TW); Sue-May Chen, Taipei City (TW); Jauder Jeng, Taichung City (TW)

(73) Assignee: INDUSTRIAL TECHNOLOGY RESEARCH INSTITUTE, HSINCHU (TW)

(21) Appl. No.: 13/554,138

(22) Filed: Jul. 20, 2012

(30) Foreign Application Priority Data
Sep. 29, 2011 (TW) 100135343

(51) Int. Cl. C08L 67/04; B32B 7/12; C09D 11/10; C08K 5/1515; C09J 167/04

(52) U.S. Cl. 428/355 R; 524/114; 522/75

(57) ABSTRACT

A resin composition, a resin and a method for manufacturing the same. The resin composition includes a plant oil derivative, and a multifunctional carboxylic acid, anhydride compound or a copolymer containing anhydride. The multifunctional carboxylic acid, the anhydride compound or the copolymer containing anhydride has an amount of 5-60 parts by weight relative to 100 parts by weight of the plant oil derivative.

This application claims the benefit of Taiwan application Serial No. 100135343, filed Sep. 29, 2011, the disclosure of which is incorporated by reference herein in its entirety.

### BACKGROUND

1. Technical Field

The disclosed embodiments relate in general to a resin composition, a resin and a method for manufacturing the same.

2. Description of the Related Art

A conventional resin is mainly made from petroleum products. However, petroleum products consume a large amount of limited resources. Besides, some resin which can only be used once cannot be recycled and is discarded as waste after use. Such resin is unfriendly to the environment and causes extra burden to the environment.

### SUMMARY

A resin composition is provided. The resin composition comprises a plant oil derivative, a multifunctional carboxylic acid, a multifunctional anhydride compound or a copolymer containing anhydride. The multifunctional anhydride compound, the multifunctional carboxylic acid or the copolymer containing anhydride has an amount of 5-60 parts by weight relative to 100 parts by weight of the plant oil derivative.

A method for manufacturing a resin is provided. The method comprises following steps. The above resin composition is provided. The resin composition is gelatinized or cured to form a polymer. The polymer is solidified or semi-solidified to form the resin. The solidifying or semi-solidifying method comprises cooling the polymer.

A resin is provided. The resin is formed according to the method disclosed above.

An adhesive tape is provided. The adhesive tape comprises a base and a glue disposed on the base. The glue is formed according to the method for manufacturing a resin disclosed above

### BRIEF DESCRIPTION OF THE DRAWINGS

None

### DETAILED DESCRIPTION

In embodiments, a resin composition may comprise a plant oil derivative and a multifunctional carboxylic acid, a multifunctional anhydride compound or a copolymer containing anhydride. The plant oil derivative may comprise epoxidized plant oil, maleinized plant oil or acrylic-based plant oil, such as epoxidized soybean oil, maleinized soybean oil, acrylic-based soybean oil, epoxidized olive oil, maleinized olive oil, acrylic-based olive oil, epoxidized almond oil, maleinized almond oil, acrylic-based almond oil, epoxidized corn oil, maleinized corn oil, acrylic-based corn oil, epoxidized cottonseed oil, maleinized cottonseed oil, acrylic-based cottonseed oil, epoxidized linseed oil, maleinized linseed oil, acrylic-based linseed oil, epoxidized grape seed oil, maleinized grape seed oil, acrylic-based grape seed oil, epoxidized peanut oil, maleinized peanut oil, acrylic-based peanut oil, epoxidized safflower seed oil, maleinized safflower seed oil, acrylic-based safflower seed oil, epoxidized sesame oil, maleinized sesame oil, acrylic-based sesame oil, epoxidized sunflower oil, maleinized sunflower oil, acrylic-based sunflower oil, epoxidized walnut oil, maleinized walnut oil or acrylic-based walnut oil. The multifunctional carboxylic acid, the multifunctional anhydride compound or the copolymer containing anhydride may comprise multifunctional oxalic acid, citric acid, itaconic acid, tartaric acid, succinic acid, maleic acid, itaconic anhydride, succinic anhydride, maleic anhydride or a copolymer of itaconic anhydride and poly lactic acid. The multifunctional carboxylic acid, the multifunctional anhydride compound or the copolymer containing anhydride can provide a molecular chain of the resin composition with an extension. The multifunctional carboxylic acid, the multifunctional anhydride compound or the copolymer containing anhydride has an amount of 5-60parts or 10˜40 parts by weight relative to 100 parts by weight of the plant oil derivative.

The resin composition may further comprise a monofunctional carboxylic acid or a monofunctional anhydride compound, such as lactic acid (monomer), acetic acid, propionic acid, acrylic acid, mathacrylic acid (MAA), acetic anhydride or acrylic anhydride. During a formation and synthesis process for the monofunctional carboxylic acid or the anhydride compound, cross-linking overreaction is avoided and the thermal stability of the resin composition is maintained. The monofunctional carboxylic acid or the anhydride compound has an amount of 0.1˜40 parts by weight or 2˜25 parts by weight relative to 100 parts by weight of the plant oil derivative.

The resin composition may further comprise polylactic acid (PLA). The polylactic acid may have an amount of 0.1˜1200 parts by weight or 0.1˜1000 parts by weight relative to 100 parts by weight of the plant oil derivative. In the embodiments, the weight-average molecular weight of polylactic acid ranges about 400˜5000.

The resin composition can be used for forming a resin. Particularly, for example, a method for manufacturing the resin may comprise gelatinizing or curing the resin composition to form a polymer and then solidifying or semi-solidifying the polymer to form the resin. A method for gelatinizing or curing the resin composition may comprise heating the resin composition (for example, at a temperature above 90 or between 90˜160 for over 2 hours or for 2˜24 hours). A method for solidifying or semi-solidifying the polymer may comprise cooling the polymer.

Compared to the polymer, the resin is almost lack of liquidity and has strong viscosity. The polymer with high liquidity has excellent coatability. In some embodiments, the resin can be transformed back into the polymer by heating. In addition, the polymer can still be transformed into the resin by cooling. The melting temperature of the resin is above 70° C. The polymer can be transformed into the resin by cooling down to below 40° C. such as the room temperature. The resin which can be recycled is environmental friendly and is convenient for use.

The resin composition may further comprise a photoinitiator. In some embodiments, the photoinitiator may be added to the polymer. In the embodiment in which the photoinitiator is used, the method for solidifying or semi-solidifying the polymer may comprise irradiating the polymer with a light. In some embodiments, the method for solidifying or semi-solidifying the polymer may comprise irradiating the resin formed by cooling the polymer. The use of photoinitiator strengthens the cross-linking of the resin.

In embodiments, the polymer may be used as an adhesive. The resin may be used as a glue or a printing ink. The resin composition, the polymer and the resin can be used for manufacturing an adhesive tape. In one embodiment, a method for manufacturing the adhesive tape comprises coating a melted polymer on a base, and cooing the polymer for forming the adhesive tape. In the embodiment in which the photoinitiator is used, the method for manufacturing the adhesive tape may comprise coating a melted polymer on a base and then irradiating the polymer (for example, with a UV light) to form the adhesive tape. For example, the base may have a material, comprising paper, polypropylene, polyvinyl chloride (PVC), polyethylene, polyethylene terephthalate (PET), polyimide (PI), or fiber cloth.

A number of embodiments are disclosed below to provide detailed descriptions of the disclosure.

### <Polylactic Acid>

A reactant of 14.41 g of lactic acid (monomer) and a catalyst of 1.21 g of stannous 2-ethylhexanoate are put into a three-port reaction flask. The reaction flask is bathed in an oil at 90° C., and an air is led into the reaction flask.

The solution is mixed by a rotation rate of 250 rpm. After the solution is reacted for 2 hours, the pressure is decreased by a pressure reducing pump and the temperature is increased at a rate of 10° C. per 10 minutes until 170 is reached. The condition is maintained for 2 hours. After the solution is cooled, a polylactic acid being a polylactic acid oligomer whose weight-average molecular weight (Mw) amounts to about 2,400 is obtained.

### <Solution A Containing Epoxidized Soybean Oil>

49.43 g of epoxidized soybean oil (ESBO B-22, made by Chang Chun Plastics Co., LTD, with the oxirane no. being about 6.61%) is mixed with 0.49 g of triphenyl phosphine (TPP). The mixture is then bathed in an oil at 90° C. and stirred for about 30 minutes until the TPP is completely dissolved in the epoxidized soybean oil so as to form a solution A containing the epoxidized soybean oil.

### Embodiment 1

After 0.2755 g of lactic acid (monomer) of 85% are added to 3 g of the solution A containing the epoxidized soybean oil, 6 g of polylactic acid (Mw is about 2,400) and 0.867 g of itaconic anhydride of 97% are added to the solution. The mixture is bathed in an oil at 90 and stirred for about 30 minutes until the itaconic anhydride and the polylactic acid are completely dissolved in the epoxidized soybean oil. Then, the oil bath is heated to 130 for 5 hours to obtain a polymer. A resin is formed after the polymer is cooled to the room temperature.

### Embodiment 2

Embodiment 2 is similar to embodiment 1 except that the dosage changes to 0.1377 g of the lactic acid (monomer) of 85% and 9 g of the polylactic acid.

### Embodiment 3

Embodiment 3 is similar to embodiment 1 except that the dosage changes to 0 g of the lactic acid (monomer) of 85% and 12 g of the polylactic acid.

### <Copolymer of Polylactic Acid and Itaconic Anhydride>

After 30 g of polylactic acid (Mw is about 2,400) are added to 1.44 g of itaconic anhydride of 97%, 0.31 g of TPP are added to the mixture. The mixture is bathed in an oil at 90° C. and stirred for about 30 minutes until the itaconic anhydride is completely dissolved in the polylactic acid. Then, the oil bath is heated to 130° C. for 3 hours. A copolymer of polylactic acid and itaconic anhydride is obtained after the solution is cooled.

### Embodiment 4

After 0.33 g of lactic acid (monomer) of 85% are added to 1.5 g of the solution A containing the epoxidized soybean oil, 7.85 g of the copolymer of polylactic acid and itaconic anhydride are added to the mixture. The mixture is then bathed in an oil at 90° C. and stirred for about 30 minutes until the copolymer of polylactic acid and itaconic anhydride is completely dissolved in the solution A containing epoxidized soybean oil. Then, the solution is heated to 130° C. for 5 hours to obtain a polymer. A resin is formed after the polymer is cooled to the room temperature.

### Embodiment 5

Embodiment is similar to embodiment 4 except that the dosage changes to 0 g of lactic acid (monomer) of 85% and 15.7 g of the copolymer of polylactic acid and itaconic anhydride.

### <Solution B Containing Epoxidized Soybean Oil>

36.49 g of epoxidized soybean oil (ESBO B-22 made by Chang Chun Plastics Co., LTD with the oxirane no. being about 6.61%) is mixed with 0.36 g of TPP. The mixture is then bathed in an oil at 90° C. and stirred for about 30 minutes until the TPP is completely dissolved in the epoxidized soybean oil so as to form a solution B containing epoxidized soybean oil.

### Embodiment 6

After 0.66 g of lactic acid (monomer) of 85% are added to 3 g of solution B containing epoxidized soybean oil, 3 g of polylactic acid (Mw is about 2,400) and 0.32 g of citric acid are sequentially added to the mixture. The mixture is then bathed in an oil 90° C. and stirred for about 30 minutes until the polylactic acid and the citric acid are completely dissolved in the epoxidized soybean oil. Then, the solution is heated to 130 for 5 hours to obtain a polymer. A resin is formed after the polymer is cooled to the room temperature.

### Embodiment 7

After 0.546 g of lactic acid (monomer) of 85% are added to 3 g of the solution B containing epoxidized soybean oil, 0.867 g of itaconic anhydride of 97% are added to the mixture. The mixture is then bathed in an oil at 90° C. and stirred for about 30 minutes until the itaconic anhydride is completely dissolved in the epoxidized soybean oil. Then, the solution is heated to 130 for 5 hours to obtain a polymer. A resin is formed after the polymer is cooled to the room temperature.

### Embodiment 8

After 0.546 g of lactic acid (monomer) of 85% are added to 3 g of the solution B containing epoxidized soybean oil, 0.867 grams of itaconic anhydride of 97% are added to the mixture. The mixture is then bathed in an oil at 90° C. and stirred for about 30 minutes until the itaconic anhydride is completely dissolved in the epoxidized soybean oil. Then, the solution is heated to 130° C. for 5 hours. Then, the temperature of the oil is cooled to 70° C. 0.06 g of photoinitiator (Ciba® IRGACURE® 184) are added to the melted mixture and the mixture is stirred for 10 minutes to obtain a polymer. After the polymer is cooled to the room temperature, the polymer is irradiated by a light (the exposure energy is 3000 mJ/cm²) to form a resin.

### COMPARISON EXAMPLE 9

After 1.24 g of lactic acid (monomer) of 85% are added to 3 g of the solution B containing epoxidized soybean oil, 0.072 g of itaconic anhydride of 97% are added to the mixture. The mixture is then bathed in an oil at 90° C. and stirred for about 30 minutes until the itaconic anhydride is completely dissolved in the epoxidized soybean oil. Then, the solution is heated to 130° C. for 5 hours to obtain a polymer. A resin is formed after the polymer is cooled to the room temperature.

### COMPARISON EXAMPLE 10

Comparison example 10 is similar to comparison example 9 except that the dosage changes to 0 g of the lactic acid (monomer) of 85%, 0 g of the itaconic anhydride and 40 g of polylactic acid (Mw is about 2,400).

### <Test of Glue Characteristics of Resin>

The test results of glue characteristics of the resin are illustrated in Table 1.

TABLE 1

| | Adhesion With | Adhesion | Adhesion force | |
|---|---|---|---|---|
| | Kraft Paper | With PET | (g/25 mm) | Stickiness |
| Embodiment 1 | ⊚ | ⊚ | 896 | ⊚ |
| Embodiment 2 | ⊚ | ⊚ | 1113 | ⊚ |
| Embodiment 3 | ⊚ | ⊚ | >1210 | ⊚ |
| Embodiment 4 | ⊚ | ⊚ | 455 | ⊚ |
| Embodiment 5 | ⊚ | ⊚ | >1299 | ⊚ |
| Embodiment 6 | ⊚ | ⊚ | 96 | ⊚ |
| Embodiment 7 | ⊚ | ⊚ | 150 | ⊚ |
| Embodiment 8 | ⊚ | ⊚ | 230 | ⊚ |
| Comparison | X | X | Too Weak To | X |
| Example 9 | | | Be Tested | |
| Comparison | X | X | Too Weak To | ⊚ |
| Example 10 | | | Be Tested | |

Designations:
⊚: Excellent
o: Good
X: Poor

<Adhesion with Kraft Paper>

In embodiments 1˜7 and comparison examples 9˜10, the method for testing the adhesion between a Kraft paper and the resin comprises following steps. The resin melted by placing in an oven at 100° C. for 20 minutes to form a polymer. The polymer is then coated on a PET film whose thickness is 188 μm and width is 25 mm. After the polymer is cooled to the room temperature and becomes a resin, the PET film having the resin thereon is attached to the Kraft paper. Then, the PET film is fixed on a desk surface. Then, the Kraft paper is pulled with hands to check whether the resin applies adhesion on the Kraft paper.

The testing method of embodiment 8 is similar to the aforementioned method except that after the polymer coated on a PET film having a thickness of 188 μm and a width of 25 mm is cooled to the room temperature, the polymer is further irradiated by a UV exposure machine to form the resin (the exposure energy is about 3000 mJ/cm2).

The test results in Table 1 show that in embodiments 1˜8, a significant force is required for separating the Kraft paper from the PET film, and this indicates that the adhesion between the PET film and the Kraft paper is excellent. The test results of comparison examples 9 and 10 show that the Kraft paper from the PET film can be separated by a light force, and this indicates that the adhesion between the PET film and the Kraft paper is weak.

<Adhesion with PET>

The method for testing the adhesion between the resin and a PET film is similar to the method for testing the adhesion between the resin and the Kraft paper. One PET film having the resin thereon is attached to another PET film and is then fixed on a desk surface. Then, the other PET film is pulled with hands to check whether the resin applies adhesion on the PET film. The test results of embodiments 1˜8 of Table 1 show that a significant force is required for separating the two bonded PET films apart. The test results of comparison examples 9 and 10 show that the two bonded PET films can be separated by a light force, and this indicates that the adhesion between the two bonded PET films is weak.

### <Adhesion Force>

In embodiments 1˜7 and comparison examples 9 and 10, the method for testing adhesion force comprises following steps. A polymer is coated on a Kraft paper of a width of 25 mm. After the polymer is cooled to the room temperature, the polymer becomes a resin. Then, the Kraft paper having the resin thereon is attached on a glass base. The adhesion force between the Kraft paper and the glass base is measured with a pull machine.

The testing method of embodiment 8 is similar to the aforementioned method except that after the polymer coated on a PET film of a width of 25 m is cooled to the room temperature, the polymer is further irradiated by a UV exposure machine to form the resin (the exposure energy is about 3000 mJ/cm2). Then, the Kraft paper having the resin thereon is attached on the glass base. The adhesion force between the Kraft paper and the glass base is measured with a pull machine.

The test results in Table 1 show that, in embodiments 1˜8, the adhesion of the resins have wide range of adhesion force. Due to the wide range of adhesion force, the resins of embodiments 1˜8 can thus be used in the products requiring different degrees of adhesion force. Compared to the resins of comparison examples 9 and 10, the resins of embodiments 1˜8 have superior adhesion force.

### <Stickiness>

The stickiness is tested by pressing the resin with a finger and checking whether the finger get the resin adherence thereon and the states of the resin after being pressed with a finger. In embodiments 1˜6 and 8 and comparison example 10, after pressing the resin with a finger, the finger does not get any resin adherence, and there are no fingerprints marked on the resin. In embodiment 7, after pressing the resin with a finger, the finger does not get any resin adherences but there are fingerprints marked on the resin. In comparison example 9, after pressing the resin with a finger, the finger get resin adherences and there are fingerprints marked on the resin.

In the embodiments of the present disclosure, the resin composition comprises a plant oil derivative, and a multifunctional carboxylic acid, a multifunctional anhydride compound or a copolymer containing multifunctional anhydride. The resin composition mainly uses a plant oil derivative which is a biomass material, and thus does not cause pollution to the environment. In the resin composition, the multifunctional carboxylic acid or the anhydride compound has an amount of 5-60 parts by weight relative to 100 parts by weight of the plant oil derivative. The resin formed by the resin composition has a wide range of viscosity and excellent performance in adhesion. Besides, the resin, which can be recycled and can be heated according to a heating method to become a polymer with high coatability, is very convenient for use.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A resin composition, comprising:
a plant oil derivative; and
a multifunctional carboxylic acid, a multifunctional anhydride compound or a copolymer containing multifunctional anhydride, wherein the multifunctional carboxylic acid, the multifunctional anhydride compound or the copolymer containing multifunctional anhydride has an amount of 5-60 parts by weight relative to 100 parts by weight of the plant oil derivative.

2. The resin composition according to claim 1, wherein the plant oil derivative comprises epoxidized plant oil, maleinized plant oil or acrylic-based plant oil.

3. The resin composition according to claim 1, wherein the multifunctional carboxylic acid, the multifunctional anhydride compound or the copolymer containing multifunctional anhydride comprises oxalic acid, citric acid, itaconic acid, tartaric acid, succinic acid, maleic acid, itaconic anhydride, succinic anhydride, maleic anhydride or a copolymer of itaconic anhydride and poly lactic acid.

4. The resin composition according to claim 1, further comprising a monofunctional carboxylic acid or a monofunctional anhydride compound, wherein the monofunctional carboxylic acid or the monofunctional anhydride compound comprises lactic acid, acetic acid, propionic acid, acrylic acid, mathacrylic acid (MAA), acetic anhydride or acrylic anhydride, the monofunctional carboxylic acid or the monofunctional anhydride compound has an amount of 0.1˜40 parts by weight relative to 100 parts by weight of the plant oil derivative.

5. The resin composition according to claim 1, further comprising a polylactic acid, wherein the polylactic acid has an amount of 0.1˜1200 parts by weight relative to 100 parts by weight of the plant oil derivative.

6. The resin composition according to claim 1, further comprising a photoinitiator.

7. The resin composition according to claim 1, wherein the plant oil derivative comprises epoxidized soybean oil, maleinized soybean oil, acrylic-based soybean oil, epoxidized olive oil, maleinized olive oil, acrylic-based olive oil, epoxidized almond oil, maleinized almond oil, acrylic-based almond oil, epoxidized corn oil, maleinized corn oil, acrylic-based corn oil, epoxidized cottonseed oil, maleinized cottonseed oil, acrylic-based cottonseed oil, epoxidized linseed oil, maleinized linseed oil, acrylic-based linseed oil, epoxidized grape seed oil, maleinized grape seed oil, acrylic-based grape seed oil, epoxidized peanut oil, maleinized peanut oil, acrylic-based peanut oil, epoxidized safflower seed oil, maleinized safflower seed oil, acrylic-based safflower seed oil, epoxidized sesame oil, maleinized sesame oil, acrylic-based sesame oil, epoxidized sunflower oil, maleinized sunflower oil, acrylic-based sunflower oil, epoxidized walnut oil, maleinized walnut oil or acrylic-based walnut oil.

8. A method for manufacturing a resin, comprising:
providing the resin composition according to claim 1;
gelatinizing or curing the resin composition to form a polymer; and
solidifying or semi-solidifying the polymer to form a resin, wherein the method for solidifying or semi-solidifying comprises cooling the polymer.

9. The method for manufacturing resin according to claim 8, wherein a method for gelatinizing or curing the resin composition comprises heating the resin composition to form the polymer.

10. The method for manufacturing resin according to claim 8, wherein the resin composition further comprises a photoinitiator, and a method for solidifying or semi-solidifying comprises irradiating the polymer.

11. A resin, wherein the resin is formed by the method comprising:
providing the resin composition according to claim 1;
gelatinizing or curing the resin composition to form a polymer; and
solidifying or semi-solidifying the polymer to form a resin, wherein the method for solidifying or semi-solidifying comprises cooling the polymer.

12. The resin according to claim 11, wherein the resin is used as an adhesive, a glue or a printing ink.

13. An adhesive tape, comprising:
a base; and
a glue disposed on the base, wherein the glue is formed by the method comprising: providing the resin composition according to claim 1;
gelatinizing or curing the resin composition to form a polymer; and
solidifying or semi-solidifying the polymer to form the glue.
